(19) United States
(12) Patent Application Publication
(10) Pub. No.: US 2011/0292963 A1
(43) Pub. Date: Dec. 1, 2011

(54) LASER POSITION DETECTION SYSTEM

(75) Inventors: Ryan C. Banfield, Merrimack, NH (US); Donald L. Banfield, Merrimack, NH (US)

(73) Assignee: Conductive Compounds, Inc., Hudson, NH (US)

(21) Appl. No.: 13/016,156

(22) Filed: Jan. 28, 2011

Related U.S. Application Data
(60) Provisional application No. 61/299,112, filed on Jan. 28, 2010.

(51) Int. Cl. G01N 25/00

(52) U.S. Cl. 374/6

(57) ABSTRACT

A laser or other heat source detection device is produced by creating a grid pattern on a polymer backing. The grid pattern comprises a PTC compound heat resistive ink in the form of discrete elements coupled by conductive ink lines or stripes. A resistance measurement device measures for an increase in resistance somewhere in the grid which indicates a laser or other heat source being directed at the grid. The laser detection device further comprises a cover material of heat transmissive material such as aluminum. In one embodiment, the resistance measurement device is capable of rapidly detecting the exact location of the laser source and relaying this position to a laser position control. The laser position control directs the positioning of the laser source and can either adjust or maintain the position of the laser source based on the feedback provided by the resistance measurement device or can shut down the laser and can record the time that the event took place.

### CROSS-REFERENCE TO RELATED APPLICATIONS

This application claims priority to U.S. Provisional Application No. 61/299,112 filed on Jan. 28, 2010 entitled “Laser Position Detection System”, which is incorporated fully herein by reference.

### TECHNICAL FIELD

The present invention relates to a method and system for locating the position of a movable laser or other directable heat source or source that could generate heat on the surface of a material it made contact with and more particularly, relates to the use of a positive thermal coefficient (PTC) carbon ink to locate the position of a laser and in one embodiment, to make positional corrections. In another embodiment, the system and method acts as an emergency shutoff for the laser or other directable heat source if the laser or other directable heat source enters an area that it should not be in.

### BACKGROUND INFORMATION

Lasers are utilized in many applications. For example, lasers can be precisely controlled to be used as precise cutting devices to cut metal, cloth and other material. Such lasers utilize laser detection and positioning devices to control the location of a laser within a predetermined area, typically measured within an x and y axis or grid. These devices must be precisely accurate in order to be effective.

Occasionally, the positioning of the laser devices goes astray and it would be useful to have a simple, low cost yet accurate way of detecting that the laser has gone astray and in some instances, provide feedback as to the current position of the laser in order to guide it back to the desired position and in other instances, to perhaps shut off the laser if it goes astray and/or for safety and regulatory compliance and corrective action it would be important to know the time and location of the laser going astray.

Positive temperature coefficient (PTC) is a heat-sensitive resistance compound that is used for manufacturing electric devices. PTC is known for its ability to increase internal resistance as temperature is increased. As detailed in U.S. Pat. No. 5,677,662, PTC is a compound that exhibits an extremely low resistance (a few hundredths of an ohm) or up to several thousand ohms at low or normal operating temperatures (up to approximately 80° C.), but wherein its resistance increases suddenly to tens or hundreds of ohms above these temperatures.

Silver ink is a conductive material that is resistant to flexing and creasing. Silver ink and other conductive inks have been used to allow a circuit to be drawn on a variety of materials. The conductive ink is an inexpensive way to print circuit boards on plastic sheets and has been used where flexibility is important. Silver ink will adhere to polymer films and materials and is a low cost conductive material option.

Accordingly, there is a need to improve upon the prior art to create a laser or other heat source detection and tracking device that combines accuracy and a simplified, low cost design with means of measuring laser locations and making immediate changes and adaptations to the laser location that is relatively inexpensive and adaptable to many applications.

### SUMMARY

One aspect of the present invention comprises a laser or other heat source errant position detection device (herein after referred to as a laser position detection device) that is produced by creating a printable ink grid on a polymer backing. The ink grid comprises multiple rows and columns of areas of PTC compound ink connected by strips of conductive silver ink, placed on the polymer sheet in a grid-like pattern. The laser position detection device further comprises a cover material of black anodized or non-anodized aluminum or the like.

The method of using the laser position detection device includes the use of a laser or other rather narrow beamed heat source. The laser position detection device is typically placed alongside or in the general vicinity of where the laser or other heat source will be directed in order to detect that the laser or other heat source has gone astray from its intended position. The laser position detection device is capable of rapidly detecting that the laser has moved from its intended position to instead be focused on the laser position detection device. In one embodiment, the exact location of the laser may be determined and relayed to a laser position control system that can reposition the laser. The laser position control system directs the positioning of the laser source and can adjust or maintain the position of the laser source based on the feedback provided by the laser position detection device. The control system can also record the time that the laser deviated from its programmed path onto the printed array.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention.

### BRIEF DESCRIPTION OF THE DRAWINGS

These and other features and advantages of the present invention will be better understood by reading the following detailed description, taken together with the drawings wherein:

FIG. 1 is a schematic perspective view of a laser system incorporating the laser position detection system of the present invention;

FIG. 2 is a perspective close-up view of the grid of the laser position detection device which forms part of the laser position detection system of the present invention; and

FIGS. 3A and 3B are side views of the laser position detection device of the present invention.

### DETAILED DESCRIPTION OF THE PREFERRED EMBODIMENTS

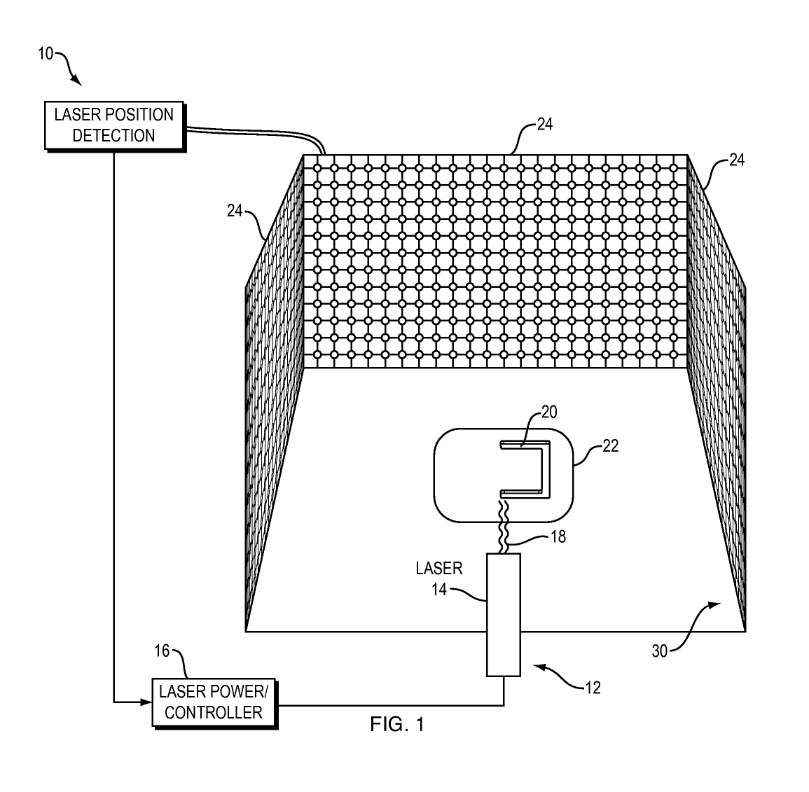

The present invention features a laser (or other directable heat source) position detection system 10, FIG. 1, designed to for use with a laser system 12 which incorporates a laser or other heat source generating device 14 coupled to a power supply and controller 16 to produce a generally directed laser beam 18 or other high energy source which causes heat. The laser 14 is typically designed to perform a predetermined function such as cutting a groove 20 on a work piece 22 such as a piece of metal, plastic or the like.

The laser 14 under control of a controller 16 typically remains pointed at the work piece 22. Often, however, and potentially unfortunately, the laser 14 may become pointed in a different direction rather than at the work piece 22. In such situations, the laser beam 18 may be harmful to humans or other products or areas closed by. In such a situation, it is desirable to be able to quickly determine that the laser beam is not pointed in the desired direction (i.e. at the work piece 22) and to either immediately shut down the laser or reposition it in the proper direction.

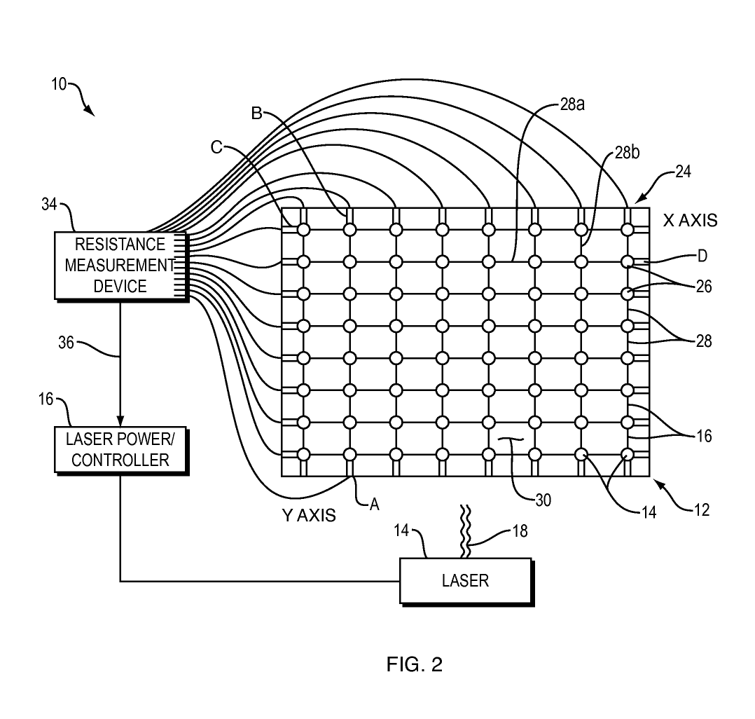

The laser position detection system 10 includes one or more resistance measurement devices 24, FIGS. 1 and 2. The resistance measurement device 24 includes a number of resistive elements 26 (illustrated by circles but the resistive elements 26 could be of any other shape such as squares, nested squares or the like, (although the geometry of these patterns is not a limitation of the invention) coupled by lines or strips 28 formed by a conductive material.

The resistive elements can range in size from approximately 1 mm to 7 mm, although this size in not a limitation of the invention.

In the preferred embodiment, the resistive elements 26 are preferably printed elements of a printable compound of positive temperature coefficient (PTC) ink or the like, while the lines or strips 28 connecting each resistive element 26 are preferably formed by a printable conductive ink, such as silver ink. The lines or strips 28 could also be comprised of copper strips made using traditional copper etched circuitry or other means for creating fixed lines of conductive materials to create a conductive path on the surface of a substrate. Although preferably, the spacing of the grid pattern of resistive elements 26 and conductive lines 28 is generally uniform and rectangular, this is not a limitation of the present invention as other spatial orientations and configurations are within the scope of the present invention as would be understood by someone skilled in the art.

Each “row” or “column” of the printed pattern of resistive elements 26 and conductive lines 28 form a low resistance path. The measurement of the resistance or at least change in resistance of each signal path, as will be described in greater detail below, allows the present system and method to detect that a laser or other heat source is striking or directed towards the resistive measurement “panel” 24 of the present invention.

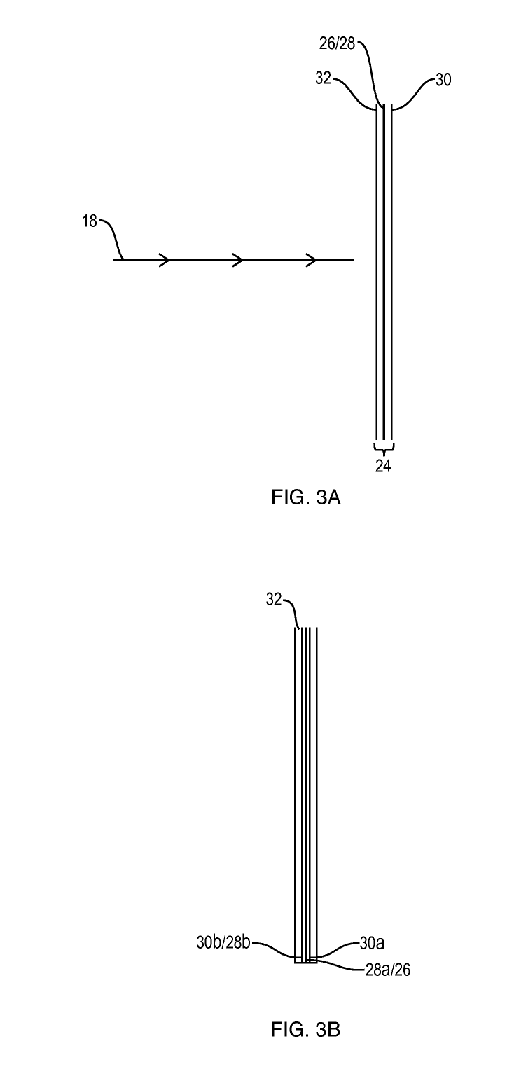

In a first embodiment, the printed grid 24 of resistive elements 26 coupled by conductive lines 28 is sited or provided on a single backing material layer 30, FIG. 3. The backing material 30 is preferably a polymer material, such as a polycarbonate, but may be any type of insulative material such as, but not limited to, urethane, acrylic, fabric, textile, FR4, polyethylene, polypropylene, wood, paper or the like. The backing material 30 may be translucent. Either the silver ink lines 28 or the PTC resistive elements 26 may be printed first onto the backing material 30, followed by the printing of the other material. The printing of PTC compound containing ink and silver ink is within the knowledge of those skilled in the art and need not be explained in detail herein.

In another embodiment, the backing material layer 30 may actually comprise two (2) layers separated by a middle electrically insulative layer; a first layer 30a on which is applied the pattern of PTC resistive elements 26 and one of either the rows (horizontal) of conductive lines 28a or the columns (vertical) of conductive lines 28b, and a second backing material layer 30b on which is provided the same corresponding pattern of PTC resistive elements 26 and the other of either the rows (horizontal) of conductive lines 28a or the columns (vertical) of conductive lines 28b. This multi-layer construction is particularly well suited when trying to build large area grid as this construction will eliminate or at least reduce the amount possible false or mis-reads.

Finally, a cover material 32 is preferably applied over the printed resistive elements 26 and connecting conductive lines 28 grid created by the PTC and silver ink. The cover material 32 protects the printed ink grid 12 from the laser beam 18 that might impinge on the resistance measurement device 24. The cover material 32 is preferably a thin sheet of black or other color anodized or non-anodized aluminum material or another material that similarly protects the underlying ink grid by absorbing heat from the laser or other directable source of heat without being destroyed. The cover material 32 is designed to absorb the laser energy and transfer the heat of the laser energy to the underlying grid.

The laser position detection system 10 in accordance with the present invention includes a resistance measurement device 34, FIG. 2, preferably in the form of a standard “ohm meter” type device. The resistance measurement device 34 is preferably connected to the “top” (point B) and “bottom” (point A) and “left-hand side” (point C) and “right-hand side” (point D) of each row and column of the grid on the panel 24. Each of the individual connections can be fed into a programmed device to continuously monitor, capture and interpret each individual electrical signal from all of the connections. In this manner, the resistance measurement device 34 can immediately detect a rise in resistance in any row and column and provide an indication 36 to the laser power and controller 16 that will either shut down the laser 14 or if the resistance measurement device is connected independently to each row and column of the grid, determine the exact position of the laser and the time that the hit occurred and provide that information to the laser power controller 16 to cause the laser 14 to be repositioned in the proper orientation and the time of the correction can be recorded. In another embodiment, each of the left hand and right hand as well as top and bottom electrical connections of the grid may be connected in series in which case the resistance measurement device 34 can only determine that a heat source has been directed at the grid but cannot isolate the exact position of the heat source on the grid.

The method of using the laser position detection system 10 in accordance with the present invention involves monitoring for the application of a laser or other heat source beam 18 to the surface of the resistance measurement device 24. The laser source beam 18 will contact the cover material 30, which will absorb at least a portion of the laser energy without being destroyed. The heat on the resistive elements 26 below the cover material 30 will cause the resistance and a specific row/column in the grid as a whole to rise thereby indicating that a heat source has been directed towards the panel. Alternatively, as mentioned above, the position of the laser beam 18 may be determined as being a location relative to the x and y axis. The PTC ink compound 26 is especially suited to the rapid detection of the location of the laser beam 18 because the PTC ink 14 exhibits a rapid and sudden significant increase in resistance when exposed to the heat from the laser beam 18. This rapid response allows the resistance measurement device 34 to at least detect if not exactly pinpoint the laser beam 18 within the grid 24 and to rapidly relay this information to the laser power/controller 16.

Accordingly, the present invention provides a low cost yet highly reliable system and method of detecting that a laser or other heat source is being directed to an area wherein the laser or heat sources not supposed to be pointing into either shut down the power to the laser or other heat source or to provide a control signal to a controller which can repositioned the laser or other heat source in the proper orientation and record the time that the event occurred.

Modifications and substitutions by one of ordinary skill in the art are considered to be within the scope of the present invention, which is not to be limited except by the allowed claims and their legal equivalents.

The invention claimed is:

1. A detection and resistance measurement device for determining the location of a directable heat source comprising:
at least one polymer backing material layer;
an grid sited on at least a first surface of said at least one polymer backing material, wherein the grid includes a printed pattern or grid including a combination of PTC compound heat resistive ink elements coupled by lines or stripes of conductive material;
a resistance measurement device, coupled to said rows and columns of a combination of PTC compound ink heat resistive elements coupled by lines or stripes of conductive material, and configured for at least detecting an increase in resistance in any of said rows or columns and responsive to said determination of an increase in resistance, for providing an indication that a heat source is impinging on said grid; and
a cover material placed over the grid, wherein the cover material is capable of absorbing heat energy and transferring said heat energy to said grid underlying said cover material.

2. The detection and resistance measurement device of claim 1, wherein said directable heat source is a laser.

3. The detection and resistance measurement device of claim 1, wherein said at least one polymer backing material layer includes two polymer backing material layers, and wherein a first portion of said grid is provided on a first surface of a first of said two polymer backing material layers, and wherein a second portion of said grid is provided on a first surface of a second of said two polymer backing material layers, and wherein at least a portion of said first and said second portions of said grid are electrically coupled together.

4. The detection and resistance measurement device of claim 1, wherein said resistance measurement device is configured to record the time and the location that said heat directable source has impinged on said grid.

5. A detection and resistance measurement device for determining the location of a directable heat source comprising:
at least one polymer backing material layer;
an grid sited on at least a first surface of said at least one polymer backing material, wherein the grid includes a printed pattern or grid including a combination of PTC compound heat resistive ink elements coupled by lines or stripes of conductive material;
a resistance measurement device, coupled to said rows and columns of a combination of PTC compound ink heat resistive elements coupled by lines or stripes of conductive material, and configured for at least detecting an increase in resistance in any of said rows or columns and responsive to said determination of an increase in resistance, for providing an indication that a heat source is impinging on said grid and for recording the time and the location that said heat directable source has impinged on said grid; and
a cover material placed over the grid, wherein the cover material is capable of absorbing heat energy and transferring said heat energy to said grid underlying said cover material.
